(19) United States
(12) Patent Application Publication
(10) Pub. No.: US 2007/0124402 A1
(43) Pub. Date: May 31, 2007

(54) Multiple server email system

(76) Inventors: James Irwin, Kingston, NY (US); Graham McNicoll, Darien, CT (US)

Correspondence Address: REED SMITH LLP, 2500 ONE LIBERTY PLACE, 1650 MARKET STREET, PHILADELPHIA, PA, 19103, US

(21) Appl. No.: 11/583,959

(22) Filed: Oct. 18, 2006

Related U.S. Application Data
(60) Provisional application No. 60/727,633, filed on Oct. 18, 2005.

(51) Int. Cl. G06F 15/16

(52) U.S. Cl. 709/206

(57) ABSTRACT

An email system for providing improved access and increased efficiency is disclosed. The system includes a master server with substantially constant connection to the internet and at least one local server that at least periodically interfaces with the master server to create a substantially identical copy of emails and settings. The interfacing includes transmits and receives bundled emails in bursts to synchronize the master server and the at least one local server to substantially identically copy emails and settings thereby improving access and increasing efficiency. A method of synchronizing outgoing and incoming emails in a two server email system is also disclosed.

### RELATED APPLICATIONS

This application claims the benefit of U.S. Provisional Application No. 60/727,633 filed Oct. 18, 2005, and the text of application 60/727,633 is incorporated by reference in its entirety herewith.

### FIELD OF THE INVENTION

The invention relates to an email system, and, more particularly, to an email system for providing improved access and increased efficiency.

### BACKGROUND OF THE INVENTION

With the advent of the internet, electronic mail has become one of the main ways that much of the developed world communicates with each other. The main reasons for this are the speed of email and its price compared with regular “snail mail”. Despite what many people think, email is not “free,” as it historically demands a computer, an internet connection, and a mail server in order to operate. It is because of these costs that most of the developing world is not using email to communicate.

Further, small businesses and organizations throughout the world often do not have the money, the facilities, or the technical experience to set up their own dedicated mail servers. A dedicated mail server requires a computer with a constant internet connection and a static Internet Protocol (“IP”) address. It also requires a mail transfer agent (“MTA”) which handles incoming and outgoing standard Simple Mail Transport Protocol (“SMTP”) connections. MTAs may often be expensive or technically challenging to set up, secure, and manage. Furthermore, the ratio of SPAM to wanted mail has been increasing in recent years to as much as nine SPAM messages for each wanted one, thereby clogging the server's resources unnecessarily. Because of these challenges, many organizations do not provide their members with email addresses. Instead, their members, if they can access email at all, are forced to rely on free webmail services.

These free webmail services require an active internet connection when in use. Often, the services have advertisements that use far more bandwidth than the contents of the emails themselves. Such free webmail (as well as general email) email addresses come in the form of [user name]@[domain]. Free webmail services generally do not allow members that have addresses with a common domain representative of the free webmail organization.

Internet connections in much of the developing world often rely on expensive satellite connections or other unreliable connections with low bandwidth. On slow or saturated connections, it takes minutes to download a single email together with all of the advertisements. Service and power outages frequently result in people losing mail on which they were working.

Thus, in view of these challenges, a need exists for providing an easy, cheap, and efficient way to make an email fast, reliable, and web accessible.

### SUMMARY OF THE INVENTION

An email system for providing improved access and increased efficiency is disclosed. The system includes a master server with substantially constant connection to the internet and at least one local server that at least periodically interfaces with the master server to create a substantially identical copy of emails and settings. The interfacing includes transmits and receives bundled emails in bursts to synchronize the master server and the at least one local server to substantially identically copy emails and settings thereby improving access and increasing efficiency.

A method of synchronizing outgoing email and user data in a two server email system is also disclosed. The method includes receiving an email created on the local area network on a local server, pooling the received email in a database on the local server until a condition is met, connecting by the local server to a master server via an internet connection, and transferring the pooled email via the connection.

A method of synchronizing incoming email and user data in a two server email system is also disclosed. The method includes receiving an email handled by the mail transfer agent on a master server, pooling the received email in a database on the master server until a condition is met, connecting by the master server to a local server via an internet connection, and transferring the pooled email via the connection.

A method of synchronizing outgoing and incoming email and user data in a two server email system is disclosed. The method includes receiving an outgoing email created on the local area network on a local server, receiving an incoming email handled by the mail transfer agent on a master server, pooling the received outgoing email in a database on the local server until a condition is met and pooling the received incoming email in a database on the master server until the condition is met, connecting by the local server to a master server via an internet connection, and transferring the pooled outgoing email and the pooled incoming email via the connection.

A method of substantially automatically saving compositions via the internet is also disclosed. The method includes analyzing a currently composed email for changes since the last transfer, identifying the changes, sending the changes to a server with the server receiving the sent changes, and applying the received changes to previously transferred email to thereby create a substantial copy of the currently composed email.

A method of associating a address book entry with a digital sound file, and audibly alerting a user with the digital sound file upon receipt of an email corresponding to the address book entry is also disclosed. The method includes retrieving the sending address from an email, matching the sound file associated with the sending address, linking to the matched sound file, sending the link to a web browser with the web browser downloading the associated sound file from a server, and audibly alerting the user of the received email from the sending address.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 is a schematic view of a two server email system of the invention illustrating a local server and the master server;

FIG. 2 is a schematic view of the two server email system of the FIG. 1 embodiment and related connection options;

FIG. 3 is a detailed schematic view of the two server email system of the FIG. 1 embodiment;

FIG. 4A is a schematic view of the two server email system of the FIG. 1 embodiment illustrating transfer of outgoing email (also referred to herein as mail) over the two server system;

FIG. 4B is a schematic view of the two server email system of the FIG. 1 embodiment illustrating transfer of incoming mail over the two server system;

FIG. 5 is a schematic overview of the features and tools of the FIG. 1 embodiment used to automatically save compositions over the web; and

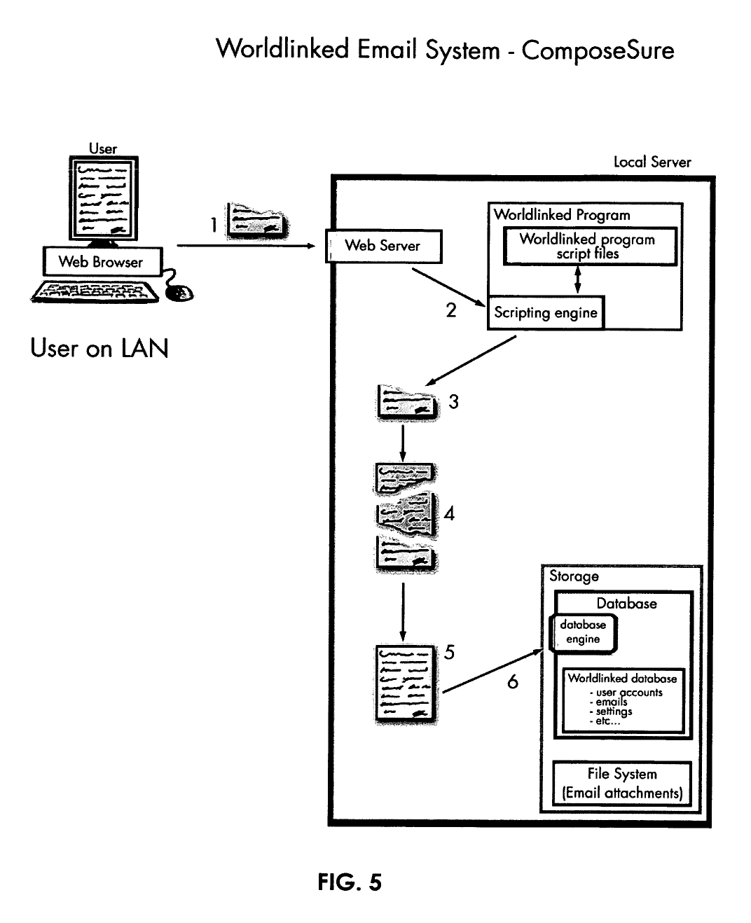

FIG. 6 is a schematic overview of the features and tools of the FIG. 1 embodiment used to play a new sound upon the arrival of new mail.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in email systems. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The present invention discloses a unique email system that uses two synchronized servers. The email system provides features for data redundancy and backup, and pool and burst for minimal connection time. It is believed that the system overcomes challenges associated with access and availability of connections, slow speeds and low bandwidth, high costs and poor quality of connections, and unreliable power supplies.

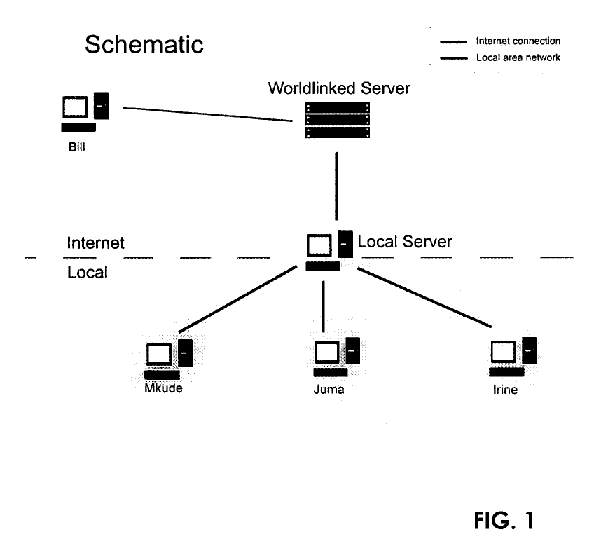

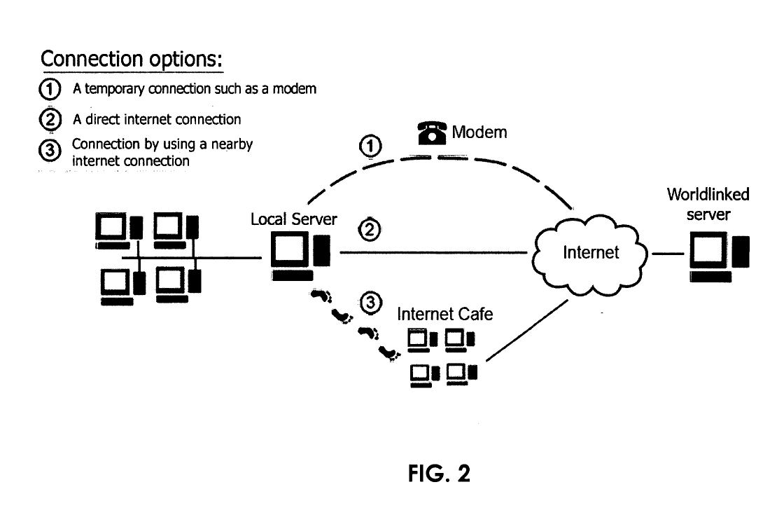

The two server email system of the present invention is illustrated with reference to the accompanying drawings in which FIGS. 1 and 2 generally describe a system of the present invention. With particular reference to FIGS. 1 and 2, there is shown an email system of the present invention with two servers. One server is the master server. The other server is the local server. The master server has a constant connection to the internet and accepts standard email protocols. It interfaces with the local server to create an identical copy of all emails and settings. In FIG. 2, there is shown an embodiment of the two server system illustrating various internet connection options, including, but not limited to, a temporary connection such as a modem, a direct internet connection, and connection by using a nearby internet connection. In addition to minimizing bandwidth usage, the system allows for flexibility in internet connection methods.

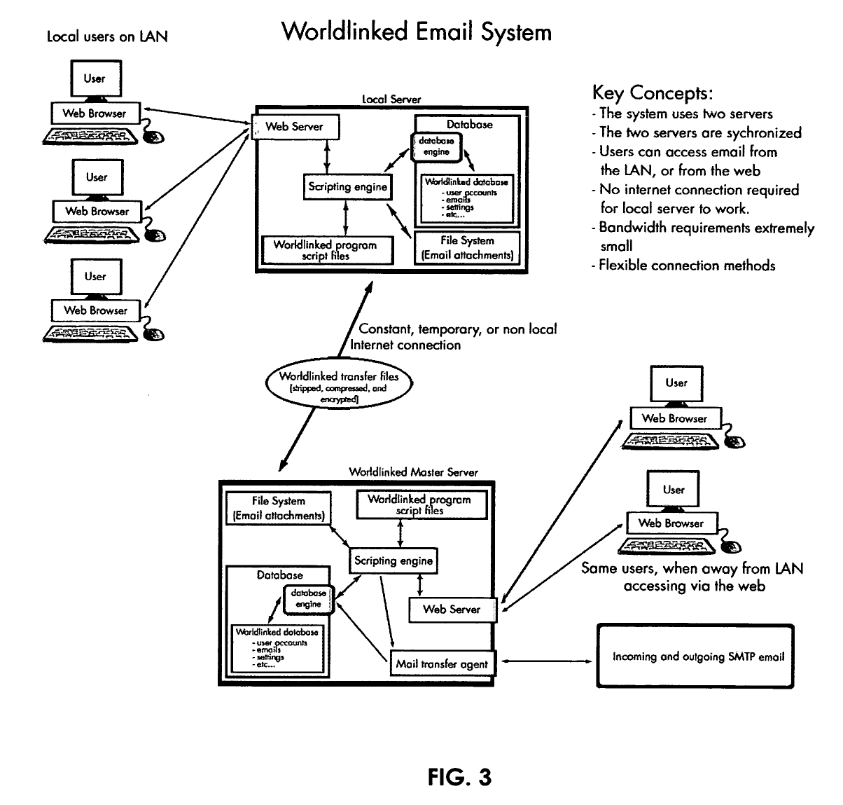

Turning now to FIG. 3, the master server has a static internet connection on which the email domains and the standard MTA (mail transfer agent—the mail server which handles incoming and outgoing standard SMTP connections) are hosted. The local server hosts email for all users on the local area network (“LAN”). The master server may serve many local servers, but the description herein refers only to a single local server, because the process is identical to a multiple local server system.

The local server runs a version of the email system program or software. The system serves all users on the LAN, enabling them to read and write emails only while connected to the local server. All outgoing emails sent are “pooled” on the local server. At a specified time or when a specified number of emails have collected, the emails will automatically be sent in one “burst.”

Similarly, new incoming email reaches the master server via SMTP (simple mail transfer protocol) and is delivered into the email system. This email is also ‘pooled’ and ready to be sent to the local server in one ‘burst’. When a connection is made between the local and the master servers, all incoming and outgoing mails are transferred. This transfer process results in a synchronization of the two servers.

Also transferred during this synchronization are any new users, user's settings, address book entries, groups, files, calendar entries, etc., such that both servers contain the same data. This synchronization allows a user to use her account from both the local server and from the master server.

The ‘pooled’ emails and settings are packaged before transferring to reduce the transfer size. This includes, but is not limited to, stripping out all of the headers except for the most essential information, and/or sending only one part of multi-part mime messages, compression, and encryption. It is also common for emails to contain large parts of previous emails, such as when replying or forwarding. This trait may be taken advantage of when transferring new emails by replacing the contents which match old emails with a marker which allows the program of the present invention to restore the missing content after it is transferred. Further, for example, it is known in the art that when an email is sent, the email often contains excess information. For example, an email may be sent with additional headers that are meant for only the computer to use, or information may be sent once in a text form and once in an html version. With the use of the present invention, the extra headers maybe cut, and only, for example, and the headers such as “To,” “From”, “CC,” and “Subject” headers sent. The two server system will also allow the local site to choose to select just the html version and not the text version or vice-versa, thereby sending only one copy of the content of the message instead of two. As a result of this two server system, a large savings of bandwidth and increased security may be achieved.

Another feature of the two server system in reducing bandwidth requirements is that all email comes through the master server before it is delivered to the local server. This routing process allows for filtering of all incoming emails to remove any misaddressed emails, spam, and viruses before bandwidth is wasted in delivering them to the local server. Administrators may also set limits on the size of allowable emails and attachments to transfer.

The synchronization process may happen over any internet connection (dialup, direct connection via DSL or cable modem, etc). The transfer may be executed at specific time intervals throughout a day or it may be transferred on any other number of conditions, such as the number of outgoing emails pooled, the number of outgoing emails for a specific user, or a specific amount of time passed. The synchronization process may also be triggered manually at any time.

In the case where there is no local internet connection available, the synchronization process may also happen by using an intermediate computer which has an internet connection. In this case, the packet of pooled emails and user data may be copied to a storage medium (such as a disk or USB memory stick), and taken to an active internet connection. On the storage medium is a transfer program which may automatically transfer the data to the master server, and download the incoming data.

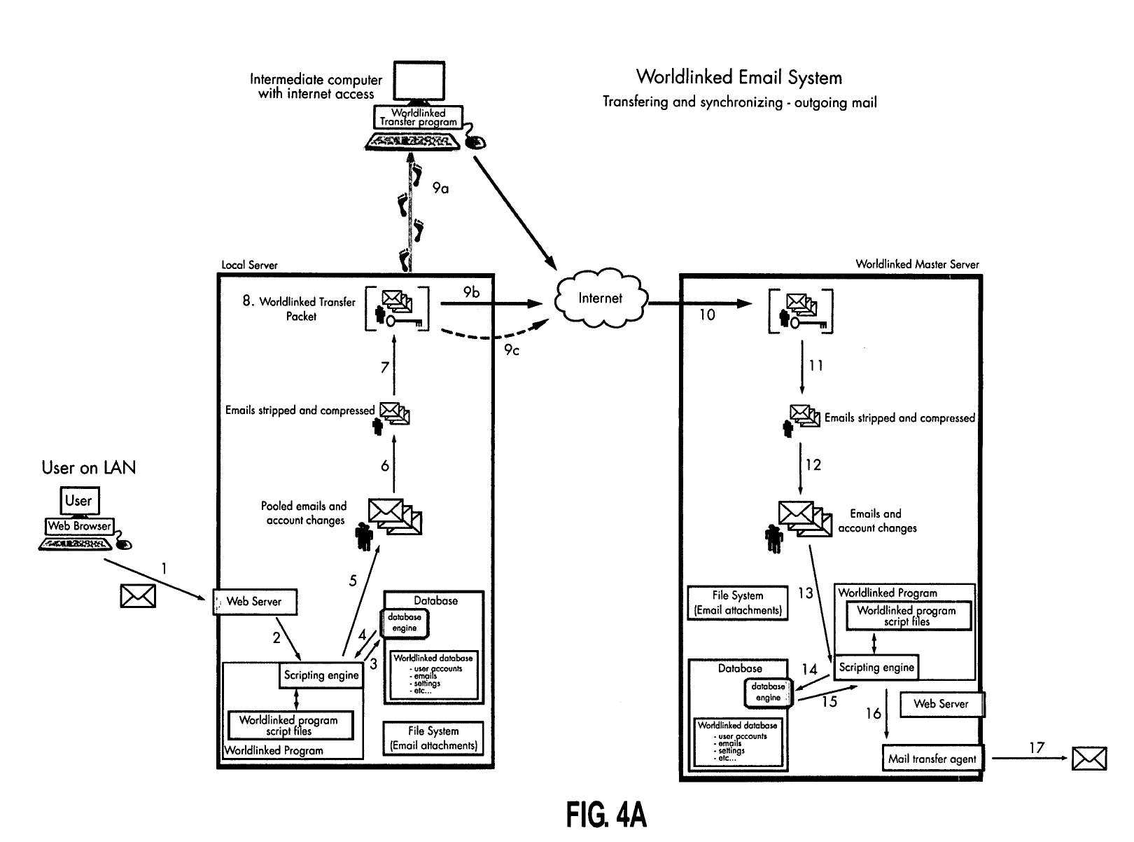

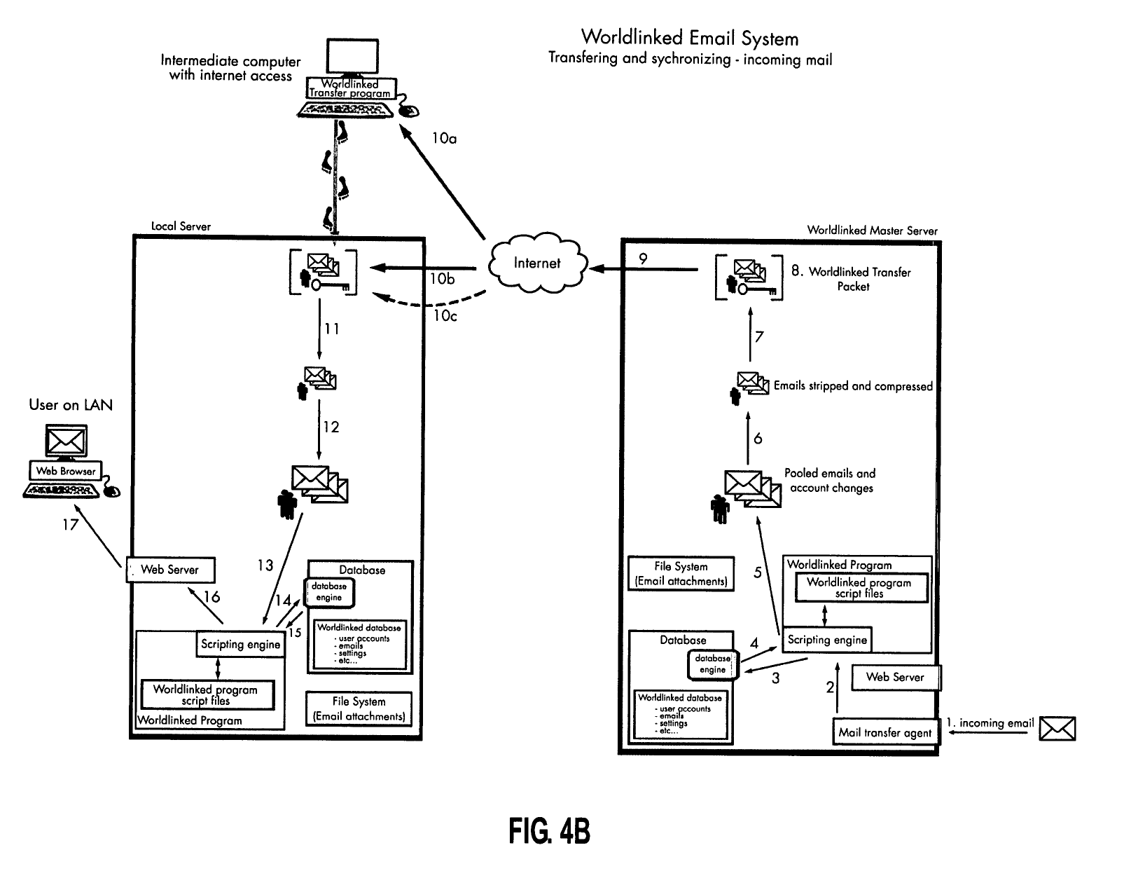

Turning now specifically to FIGS. 4A and 4B, the two-part synchronization process is illustrated. Illustrated in FIG. 4A is an embodiment of the synchronization process in which an outgoing email is sent over the two server system.

Step 1. A user on the local area network (LAN) uses a web browser to log into the email system from a computer. This user writes an email on the system and, upon pressing the send button, the email gets sent to the local server.

Step 2. The web server receives the email and relays it on to the email program.

Step 3. The email program saves the email to the database. One copy of the email is put in the users sent folder, another is stored (pooled) ready to transfer.

Step 4. When a transfer is called for, the email program collects all pooled outgoing emails together in preparation for them to be transferred to the master server.

Step 5. The email program pools these emails together with any other changes that users might have made to their account from a computer on the LAN (such as adding or removing address book entries, moving or deleting an email, etc.).

Step 6. Emails are stripped of excess and duplicate information and then compressed, with the other account changes, into an extremely reduced size transfer packet(s).

Step 7. For added privacy, (though it will slightly increase transfer packet size) the transfer packet may be encrypted.

Step 8. The transfer packet is stored and awaits the administrator of the local server to connect to the master server and perform the synchronization.

Step 9. The administrator may connect to the master server in one of three ways.

Step 9a. In the case that the local server does not have an internet connection, the administrator takes a disk with the transfer program and the transfer packet to a computer which is connected to the internet and runs the transfer program. The transfer program sends the packet through the internet to the master server.

Step 9b. In the case when the local server does have a constant internet connection, the transfer program is run on a specified time interval, or when requested by the administrator. The transfer program sends the transfer packet direct to the master server across the internet.

Step 9c. In the case when the local server has a temporary internet connection, such as a dial-up connection, the administrator runs the transfer program manually. The transfer program sends the transfer packet direct to the master server across the internet.

Step 10. The master server receives the transfer packet from the internet.

Step 11. The email program decrypts the transfer packet.

Step 12. The transfer packet is decompressed, restoring it to its original state.

Steps 13-14. The email program takes the emails and account changes and adds them to the master server, synchronizing the two servers.

Steps 15-16. The script takes the outgoing email, converts it into standard email format, and sends it to the MTA.

Step 17. The MTA sends the email across the internet using SMTP to its final recipients.

The result is that the two servers are fully synchronized, and outgoing email is sent using minimal bandwidth from the local server. The email system program or software may be written in any suitable scripting language, including a compiled stand alone one. Since all scripting languages need a scripting engine to work, and since the software may be written in any suitable scripting language, it is shown in a single box in the FIGS and described as a single unit in the text herein. The software may be written, for example, in PHP (a scripting language) which may be interpreted on the fly by the PHP engine (scripting engine in the FIGS). A database may be used in the system to store emails and user information. In place of or in addition to the database, one may use the file system or any other method known to one skilled in the art to store emails and user information.

Illustrated in FIG. 4B is an embodiment of the synchronization process in which an incoming email is retrieved from the internet and sent over the two server system. This is the second half of the two-part synchronization process and is described below:

Step 1. An incoming email is received from the web and is handled by the MTA.

Step 2. The mail transfer agent checks to make sure that the email is destined for somebody in its system and then passes it on to the email program.

Step 3. The email program saves the email to the database. One copy is put in the user's inbox, and another is stored (pooled) ready to transfer.

Steps 4-5. When the administrator of the local server connects to the master server, the email program collects all pooled incoming emails together along with any other changes that users might have made to their account from the web (such as adding or removing address book entries, moving or deleting an email, etc.) in preparation for the emails to be transferred back to the local server.

Step 6. Emails are stripped of excess and duplicate information and then compressed together with the other account changes to become ultra small transfer packets.

Step 7. For added privacy (though it will slightly increase transfer packet size) the transfer packet may be encrypted.

Step 8. The transfer packet is now ready to be sent to the local server.

Step 9. The transfer packet is sent over the internet using the connection that was already made by the local administrator.

Step 10. The transfer packet gets delivered to the local server in three ways.

Step 10a. In the case when the local server does not have an internet connection, the administrator takes a disk with the transfer program to a computer that is connected to the internet and runs the transfer program. The transfer packet is received from the internet and is put on the disk. The administrator carries the disk back to the local server where the administrator loads the transfer packet onto it.

Step 10b. In the case when the local server does have a constant internet connection, the transfer program gets run on its own, at specified time intervals. The transfer program receives the transfer packet direct from the internet.

Step 10c. In the case when the local server has a temporary internet connection, such as a dial-up connection, the administrator runs the transfer program manually. The transfer program then receives the transfer packet directly from the internet.

Step 11. A script is then run which decrypts the transfer packet.

Step 12. The script then decompresses the transfer packet.

Step 13-14. The script then takes the emails and account changes and stores them on the local server.

Steps 15-17. The users may connect to the local server over the LAN and be able to check their email quickly and without using any internet bandwidth.

In another aspect of the invention, a method of automatically saving webmail to a remote server, while a user is typing an email, using dynamic hypertext markup language (“DHTML”) techniques, is disclosed. Webmail uses a server computer to send a web page containing a form (including “to” field, “subject” field, “message” field, etc. . .) to a client computer. Using DHTML techniques (such as JavaScript), code that is sent to the client computer may be executed, and any changes that the user makes to the form may be monitored and recorded. The changes may then be sent after a delay in typing, or at regular intervals, to the server computer (using XML, HTTP or via submission of a hidden form). The server computer, upon receiving the changes, may compile the changes together with all the previous ones, to get an exact copy of the email being typed on the client computer, and the server computer may save that on the server. In this way, if the client computer crashes or experiences unexpected work interruption, the user, upon rebooting the computer, may retrieve the email they were working on from the server.

A method of automatically saving compositions (e.g., webmail), over the web, is illustrated in FIG. 4B and is described below:

Step 1. In the first step, a user continues to type an email in a web browser on the client computer. At regular intervals, a client-side script analyzes the email for any recent changes the user has made since the last transfer. The script then sends these changes to the server.

Step 2. The web server receives these changes and calls a server side-scripting engine to handle them.

Steps 3-5. The email program receives the latest changes and applies these to the other parts of the email it had previously received. In this way, the email program recreates an exact copy of the email that the user is currently working on in real time.

Step 6. The script then stores the entire email that has been written up to this point in time, on the server. Now, if the client computer crashes, the user will be able to retrieve a copy of the written email from the server.

In another aspect of the present invention, a process of associating an entry in a computer-stored address book with a digital sound file, and having that sound file play on a client computer each time the user receives an email from that person, is disclosed. This playing of the sound file will alert the user to the fact that an email has been received, and the system will inform the user who the email was from. This process is also referred to herein as an “email receipt tone system.”

For example, an email receipt tone system may be incorporated into webmail via the use of a DHTML script that regularly sends a request to a server computer and asks the server whether any new emails have arrived, for whom the emails have arrived, and which sound file to play. The DHTML code may then play the appropriate sound file on the client computer.

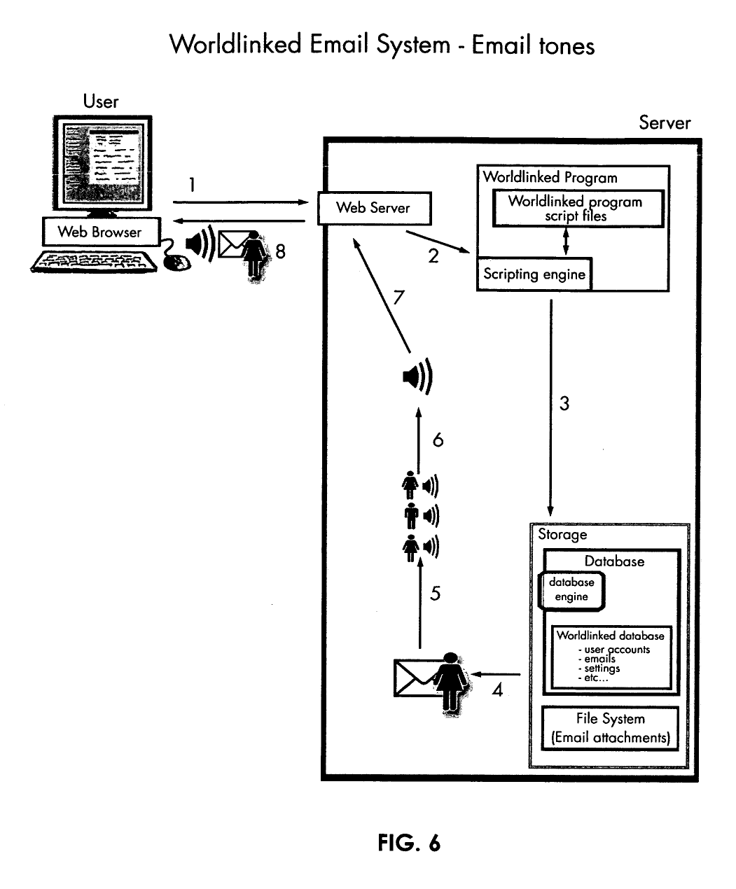

The process whereby the email receipt tone system plays a new sound upon the arrival of new mail is illustrated in FIG. 6 and is described below:

Step 1. Using a client side script, the web browser periodically calls the server to ask if any new mail has been received.

Step 2. The web server upon receiving the request calls the email program.

Step 3. The email program looks in the database for new email.

Step 4. The sender's email address is retrieved from the new email.

Step 5. The email program checks to see if that address has a sound file associated with it.

Step 6. A link to the appropriate sound file is created.

Steps 7-8. The link to the sound file is sent to the web browser, which downloads the sound file from the server and plays it, notifying the user of receipt of the new email from a particular sender.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. An email system for providing improved access and increased efficiency, said system comprising:
a master server with substantially constant connection to the internet; and
at least one local server that at least periodically interfaces with said master server to create a substantially identical copy of emails and settings,
wherein the interfacing includes transmits and receives bundled emails in bursts to synchronize said master server and said at least one local server to substantially identically copy emails and settings thereby improving access and increasing efficiency.

2. The system of claim 1, wherein said master server has a static internet connection.

3. The system of claim 2, wherein said static internet connection hosts the email domains and the mail transfer agent.

4. The system of claim 1, wherein said at least one local server hosts email for users on a local area network.

5. The system of claim 4, wherein software on said at least one local server provides users on a local area network the ability to read and write email.

6. The system of claim 1, wherein said master server accepts standard email protocols.

7. The system of claim 1, wherein software on said at least one local server pools outgoing emails on said at least one local server.

8. The system of claim 7, wherein said pooling occurs until a condition is met, said condition causing said at least one local server to interface with said master server.

9. The system of claim 8, wherein said condition is selected from at least one of a collection of a specified number of outgoing emails, a specified time, a user's command, and a specified time elapsed since the last interfacing.

10. The system of claim 1, wherein said master server pools incoming emails on said master server.

11. The system of claim 10, wherein said pooling occurs until a connection is established between said at least one local server and said master server.

12. The system of claim 1, wherein said synchronization includes at least one of establishing user settings, address books entries, groups, files, and calendar entries.

13. The system of claim 1, wherein said bundled emails includes reducing the transfer size.

14. The system of claim 13, wherein reducing the transfer size includes at least one of removing at least a portion of the headers of the messages, sending only one part of multi-part mime messages, compressing, and encrypting.

15. The system of claim 1, wherein said master server filters incoming emails to remove at least one of misaddressed email, spam, and viruses to thereby conserve bandwidth in delivering to said local server.

16. The system of claim 1, wherein said interfacing occurs over an internet connection.

17. The system of claim 16, wherein said internet connection includes at least one internet connection including dialup and direct connection via DSL and cable modem.

18. The system of claim 1, wherein said interfacing occurs using an intermediate computer device.

19. The system of claim 18, wherein said intermediate computer device includes at least one of a secondary server, a secondary network, a secondary computing device, and a storage device.

20. A method of synchronizing outgoing email and user data in a two server email system, said method comprising:
receiving an email on a local server, said email created on the local area network;
pooling the received email in a database on said local server until a condition is met;
connecting by the local server to a master server via an internet connection; and
transferring said pooled email via said connection.

21. The method of claim 20, further comprising stripping said pooled email of excess and duplicate information prior to said transferring.

22. The method of claim 20, further comprising compressing said pooled email prior to said transferring.

23. The method of claim 20, further comprising encrypting said pooled email prior to said transferring.

24. The method of claim 20, further comprising receiving said transferred email at a master server.

25. The method of claim 24, further comprising adding said received email to the master server to thereby synchronize said master server and said local server.

26. The method of claim 25, further comprising converting said added email into an email format, transferring said converted email to the mail transfer agent and sending said converted email across the internet.

27. A method of synchronizing incoming email and user data in a two server email system, said method comprising:
receiving an email on a master server, said email handled by the mail transfer agent;
pooling the received email in a database on said master server until a condition is met;
connecting by the master server to a local server via an internet connection; and
transferring said pooled email via said connection.

28. The method of claim 27, further comprising stripping said pooled email of excess and duplicate information prior to said transferring.

29. The method of claim 27, further comprising compressing said pooled email prior to said transferring.

30. The method of claim 27, further comprising encrypting said pooled email prior to said transferring.

31. The method of claim 27, further comprising receiving said transferred email at a local server.

32. The method of claim 31, further comprising adding said received email to the local server to thereby synchronize said master server and said local server.

33. The method of claim 32, further comprising accessing the added received email by accessing said local server via a local area network.

34. The method of claim 27, wherein said mail transfer agent verifies that said received email is destined for a user of the two server email system.

35. A method of substantially automatically saving compositions via the internet, said method comprising:
analyzing a currently composed email for changes since the last transfer;
identifying said changes;
sending said changes to a server, said server receiving said sent changes; and
applying said received changes to previously transferred email to thereby create a substantial copy of said currently composed email.

36. The method of claim 35, further comprising retrieving the substantial copy of said currently composed email via the internet to replace a displaced currently composed email.

37. The method of claim 36, wherein said displaced email includes emails lost as a result of local computer failure.

38. A method of associating a address book entry with a digital sound file, and audibly alerting a user with the digital sound file upon receipt of an email corresponding to the address book entry, said method comprising:
retrieving the sending address from an email;
matching the sound file associated with the sending address;
linking to said matched sound file;
sending said link to a web browser, said web browser downloading the associated sound file from a server, and audibly alerting the user of the received email from the sending address.

39. A method of synchronizing outgoing and incoming email and user data in a two server email system, said method comprising:
receiving an outgoing email on a local server, said outgoing email created on the local area network;
receiving an incoming email on a master server, said incoming email handled by the mail transfer agent;
pooling the received outgoing email in a database on said local server until a condition is met;
pooling the received incoming email in a database on said master server until the condition is met;
connecting by the local server to a master server via an internet connection; and
transferring said pooled outgoing email and said pooled incoming email via said connection.
